(19) United States
(12) Patent Application Publication
(10) Pub. No.: US 2006/0205831 A1
(43) Pub. Date: Sep. 14, 2006

(54) Process for producing blowing agents comprised of foaming agent-containing zeolites, zeolites produced thereby and methods of foaming therewith

(76) Inventor: Michael E. Reedy, Keyport, NJ (US)

Correspondence Address: HEDMAN & COSTIGAN P.C., 1185 AVENUE OF THE AMERICAS, NEW YORK, NY, 10036, US

(21) Appl. No.: 11/078,234

(22) Filed: Mar. 11, 2005

(51) Int. Cl. C08G 18/48

(52) U.S. Cl. 521/131

(57) ABSTRACT

The present invention describes methods for preparing composition(s) for use as blowing agent(s), which methods comprise exposing zeolite(s) to foaming agent(s) so that the foaming agent is carried by the zeolite, in an amount sufficient to foam foamable material, but at least 30% by weight, based on the total weight of zeolite(s) plus foaming agent(s). The appropriate foaming agent(s) can be added to the zeolite(s) by any suitable means in which the zeolite(s) are exposed to the foaming agent(s) so that the foaming agent becomes “trapped” within the zeolite internal structure. The preferred zeolites have a pore size of approximately 4A, and the preferred foaming agent is comprised of carbon dioxide. The present invention also describes the blowing agent(s) for use in foaming foamable material(s), and describes methods for preparing foamed product(s) which comprises mixing blowing agent(s) and foamable material(s) to form a first mixture; changing the temperature and pressure of the first mixture to a preselected temperature and pressure so that the blowing agent(s) evolves a gas into the foamable material, forming foamed product(s). Once foaming has occurred, the foamed product is solidified. The preferred foamable materials are polyalkenylaromatic resins, and wood-filled and wood fiber-filled thermoplastic resins.

### FIELD OF THE INVENTION

The present invention relates to compositions for use as blowing agents in processes for making foam products, especially in extrusion and injection molding processes. More specifically, the present invention comprises blowing agent compositions comprising one or more zeolites and one or more foaming agents, wherein the foaming agent(s) is carried by the zeolite(s) and evolves to form foamed products when processed with foamable materials. In addition, the present invention includes methods for preparing blowing agent compositions and for preparing foamed products from a mixture of foamable material(s) and blowing agent(s). The present invention also comprises encapsulated blowing agent composition(s), comprised of zeolite(s) and foaming agent(s) combination(s) which have been encapsulated. In its preferred embodiments, this invention relates to processes for producing carbon-dioxide-containing zeolites, the zeolites produced thereby, and the use of such zeolites as blowing agents for the production of foam products. The carbon dioxide-containing zeolites also have been found to have biocidal activity.

### BACKGROUND OF THE INVENTION

Foamed products, and in particular foamed polymer articles, are well known in the art and have many applications. Foams are used, for example, for cushioning, insulation (thermal as well as sound), protection (packaging), weight reduction, impact absorption and thermal, chemical and electrical inertness. Such applications include, for example, food packaging, building materials, wire insulation, coatings, and more. Foamed polymer articles are typically produced from foamable thermosetting resins, foamable thermoplastic resins or foamable elastomeric resins, both filled and unfilled, including wood- and wood fiber-filled foamable resins. Thermoplastic polymer foams can be made using expanded beads or conventional polymer processing techniques like extrusion molding, injection molding, reactive injection and mechanical blending. Foam extrusion typically involves melting the foamable material in an extruder, adding a gas (or a compound that is in a gaseous state at extrusion temperature and standard pressure) or a source of a gas, e.g. a chemical compound that produces a gas upon decomposition, and then extruding the molten foamable material through a die to form foamed product. The process wherein a gas is used to foam the foamable material is called physical foaming, whereas the process wherein a chemical compound which decomposes is used to foam the foamable material is called chemical foaming. Often, nucleating agents are also added to the molten foamable material so as to improve the pore size and the homogeneity of the resulting foam product, by providing nucleation sites for the formation of bubbles via release of the foaming agent.

Many different thermoplastic polymers are known to produce foamed products and these include for example polystyrene, polypropylene, polyethylene, polyester and fluoropolymers. Such foamed products are of interest because of, inter alia, their superior heat resistance, chemical inertness, incombustibility, good dielectric properties, and, in particular, insulating properties.

Processes for producing foamed products have been disclosed in, e.g., U.S. Pat. Nos. 5,726,214; 4,877,815; 3,072,583. U.S. Pat. No. 3,072,583 discloses the foaming of polyolefins using blowing agent and boron nitride as a nucleating agent. U.S. Pat. No. 4,764,538 discloses the use of boron nitride and certain inorganic salts as nucleating agents. U.S. Pat. No. 5,726,214 discloses the use of certain sulfonic and phosphonic acids as nucleating agents to foam a thermoplastic polymer through a physical or chemical foaming process.

Historically, foam products, and particularly polystyrene foam products, have been made from a number of blowing agents. For polystyrene, the C4-C6 alkanes have gathered widespread acceptance, especially pentane. A variety of normally gaseous or liquid blowing agents have also been proposed for olefinic or styrenic polymers, including virtually all of the common atmospheric gases and lower hydrocarbons. Moreover, the foaming by extrusion and molding methods is well known in the prior art and may be accomplished by a variety of techniques. Generally, blowing agents are injected into a molten resin in the extrusion process, blended, and extruded through a die to a low-pressure zone to produce a foam. Due to difficulties in blending gas foaming materials into molten resins, the foamed product often contains non-uniform foaming characteristics, such as bubbles concentrated in certain areas of the product, large bubbles and non-uniform bubble dimensions. Furthermore, the injection system necessary for introducing certain gas foaming materials into the resin results in a system that economically inhibits the addition of more than one type of blowing agent into the resin. Therefore, it is very difficult to optimize the characteristics of the foamed product. U.S. Pat. Nos. 4,344,710 and 4,424,287 disclose blowing agents which are blends of carbon dioxide and aliphatic or fully or partially halogenated hydrocarbons.

Numerous patents have been aimed at first preparing a masterbatch mix of a plasticized blowing agent and nucleator in which the blowing agent is uniformly distributed, and subsequently this premixture is added to polystyrene which is then extruded into foam. U.S. Pat. No. 4,940,735 teaches preparation of a masterbatch containing 30 to 80 weight percent of a plasticizer, 20 to 70 weight percent of blowing agent, and 10 to 20 weight percent of a cell regulator. This masterbatch mix is said to be an improvement over earlier art. U.S. Pat. Nos. 5,218,006; 5,403,865; 5,302,624; and 5,342,857 relate to processes for the production of polystyrene foams using a masterbatch comprised of monosodium citrate, sodium bicarbonate, polyalphamethylsystrene, and a block copolymer. U.S. Pat. Nos. 5,269,987; 5,595,694; 5,652,277; and 5,817,261 relate to processes and blowing agents for the production of polyalkenylaromatic foams using a combination of atmospheric and organic gases. Garcia, et al., in U.S. Pat. No. 5,234,963, teach a process and apparatus for compounding and pelletizing chemical foaming or blowing agents in a high melt resin carder to produce pelletized chemical foaming concentrates that can be used in thermoplastic resins.

Zeolites are microporous structures composed of crystalline aluminosilicates, chemically similar to clays. A useful characteristic of zeolits is their ability to undergo dehydration with little or no change in crystalline structure, producing “activated” zeolites. Dehydration of the zeolites can be performed by any method in which water can be removed from the pores of the crystalline structure, resulting in empty cavities. Dehydrated zeolites are often referred to as “activated” zeolites because once the water is removed from the zeolite pores, the zeolites have a strong tendency to fill the cavity once again with water. The desire of the zeolite to recapture water is so strong that the zeolite will accept any material that is capable of entering the cavity. If more than one material is present that is capable of entering the cavity, the zeolite will select which one occupies the cavity based on chemical characteristics, such as electrostatic attractions. Zeolites are used in many fields of technology: to dry gases and liquids, for selective molecular separations based on size and polar properties, as ion exchangers, as catalysts, as chemical carriers, in gas chromatography, and in the petroleum industry to remove hydrogen sulfide and normal paraffins from distillates. Zeolites have also been used to produce foamed products. U.S. Pat. Nos. 5,710,189; 5,847,017; 6,096,820; 6,414,071; and 6,658,050 all relate to the use of zeolites, some having added blowing agents, for use in producing foamed products.

### SUMMARY OF THE INVENTION

According to its major aspects and broadly stated, the present invention is a blowing agent composition, a method for making a blowing agent composition, and a method for using a blowing agent composition to porduce foamed product. More specifically, the present invention is a blowing agent composition comprising one or more zeolite(s) and one or more foaming agent(s). The blowing agent is mixed with a foamable material and added directly to an extruding or injection molding device to form a foamed product. The foaming agent(s) carried by the zeloite(s) will evolve at a preselected temperature and pressure, such as those used in common injection and extrusion processes, to form foamed product.

The foaming agent used can be any suitable material that will generate a gas when subjected to heating and pressure changes. The foaming agent is present in the zeolite in amounts equal to or greater than approximately 30%, preferably greater than 50%, more preferably greater than 75% by weight, of the blowing agent composition. The blowing agent composition used for these calculations includes the zeolite(s) and the foaming agent(s). Therefore, if approximately 0.5 grams of the foaming agent are used and approximately 1.0 grams of the zeolite are used, for a total weight of 1.5 grams, the foaming agent (0.5 g) comprises approximately 33% of the blowing agent composition (1.5 g). More preferably, the foaming agent is a gas or a liquid that will vaporize upon heating. Where more than one zeolite is used, whether or not more than one foaming agent is used, some foaming agent must be adsorbed by each zeolite, and the total amount of blowing agent must still be at least 30% by weight of the total weight of the zeolites plus blowing agent(s).

The foaming agent is adsorbed and is “trapped” by the zeolite crystal when the zeolite is exposed to the foaming agent, and remains trapped until the conditions, such as temperature and pressure, are altered.

When the blowing agent composition is added to a foamable material (i.e., resins, plastics, rubbers or other foamable materials), the gas is released by altering the temperature and pressure to those within a preselected range. Foaming agents may be desorbed from zeolites in the form of a gas in a variety of ways. For example, foaming agents may be desorbed by raising the temperature or lowering the pressure. When present in a foamable material, the desorbed gas forms bubbles that cause the foamable material to develop into a foamed product having a cellular structure. Accordingly, when the temperature is reduced the foamed product solidifies, leaving bubbles distrubuted throughout the foamed product. The blowing agent composition can be prepared using any suitable zeolite, or combination of zeolites, and any suitable foaming agents. Naturally occurring or synthetic zeolites may be used, such zeolites characterized by their ability to undergo dehydration with very little or no change in crystal structure, thereby providing a high internal surface area for adsorption or trapping of other molecules.

To summarize, the present invention includes methods for preparing composition(s) for use as blowing agent(s), which methods comprise exposing zeolite(s) to foaming agent(s) so that the foaming agent is carried by the zeolite, in an amount sufficient to foam foamable material, but at least 30% by weight, based on the total weight of zeolite(s) plus foaming agent(s). The appropriate foaming agent(s) can be added to the zeolite(s) by any suitable means in which the zeolite(s) are exposed to the foaming agent(s) so that the foaming agent becomes “trapped” within the zeolite internal structure. “Trapped” means to bind a molecule by adsorption, absorption, or electrostatic attraction. The present invention is further blowing agent(s) for use in a foamable material(s), said blowing agent(s) comprised of zeolite(s) and foaming agent(s), wherein the foaming agent(s) are carried by the zeolite(s). In addition, the present invention is a method for preparing foamed product(s) which comprises mixing blowing agent(s) and foamable material(s) to form a first mixture; changing the temperature and pressure of the first mixture to a preselected temperature and pressure so that the blowing agent(s) evolves a gas into the foamable material, forming foamed product(s). Once foaming has occurred, the foamed product is solidified.

Accordingly, in view of the foregoing, one embodiment of the present invention is a process for producing a blowing agent, said process comprising:

(a) drying one or more zeolite(s) to remove at least a portion of any water adsorbed in the zeolite(s); and

(b) exposing the zeolite(s) obtained from step (a) to one or more sources of foaming agent(s) so that the foaming agent(s) are adsorbed in the zeolite(s) in an amount of at least 30% by weight, based on the weight of the zeolite(s) plus foaming agent(s), to form blowing agent(s).

Preferably, alone or in combination, in the process for producing blowing agent, the zeolite has a pore size of approximately 4A; the water adsorbed in the zeolite is reduced by drying to an amount less than 10% by weight, based on the weight of the zeolite and remaining water; and the foaming agent is carbon dioxide. Also preferably, in other process embodiments, blowing agent obtained by process steps (a) and (b) is, alone or in combination, encapsulated to form an encapsulated blowing agent, and/or pelletized in a suitable carrier to form pelletized blowing agent.

Another embodiment of the present invention is blowing agent produced by any of the processes for producing blowing agent. Of course, as indicated, more than one zeolite and/or more than one foaming agent may be present in the blowing agent and may be used in any of the processes producing blowing agent, and in the appended claims, the singular includes the plural.

Another further embodiment of the present invention is a process for producing foamed product, said process comprising:

(a) heating foamable material(s) to a temperature above their melting point to form melted foamable material(s);

(b) adding to the melted foamable material(s) blowing agent(s) comprised of zeolite(s) and foaming agent(s), wherein said foaming agent(s) are present in the blowing agent(s) in an amount of at least 30% by weight;

(c) mixing the combination of foamable material(s) and blowing agent(s) under conditions which retard foaming of the foamable material(s); and

(d) subjecting the combination of foamable material(s) and blowing agent(s) to conditions which induce release of the foaming agent(s).

Preferably, alone or in combination, the foamable material is polystyrene or a wood- or wood fiber-containing thermoplastic; the foaming agent is carbon dioxide; and the heating, mixing and subjecting are carried out as part of an injection molding or extrusion molding process. And, of course, more than one foamable material, more than one zeolite and more than one blowing agent may be used in any of the processes for producing foamed product, and may be present in the resulting foamed product, and in the appended claims, the use of the singular includes the plural.

A further embodiment of the present invention is the foamed product produced by any of the processes for producing a foamed product. Preferably, the foamed product is a foamed polystyrene product, an open-cell foamed polystyrene, or a foamed wood- or wood fiber-containing thermoplastic.

### DETAILED DESCRIPTION OF THE INVENTION

Zeolites are materials with discreet channels and cages that allow the diffusion of small molecules into and out of their crystalline structures. The utility of these materials lies in their microstructures that allow access to large internal surface areas and that increase adsorptive and ion exchange capacity.

The zeolites useful in the present invention may be generally designated by the chemical formula M2/n O.Al2O3.ySiO2.wH2O in which M is a charge balancing, exchangeable cation, n is the valence of M and is 1 or 2, y is the number of moles of SiO2 and is about 1.8 to about 15, and w is the number of moles of water of hydration per molecule of the zeolite. Suitable charge balancing cations represented by M in the formula include such cations as sodium, potassium, zinc, magnesium, calcium, ammonium, tetra-alkyl and/or -aryl ammonium, lithium, Ag, Cd, Ba, Cu, Co, Sr, Ni, Fe, and mixtures thereof. The preferred cations are alkali metal and/or alkaline earth metal cations, with the proviso that, when M is a mixture of alkali or alkaline earth metals comprising sodium and potassium and/or calcium, the preferred potassium and/or calcium content is less than about 35% by weight of the total alkali or alkaline earth metal content.

The size and position of the exchangeable cation (Na, Ca, etc.) may affect the pore size in any particular type of zeolite. For example, the replacement of sodium ions in Type 4A with calcium ions produces type 5A, with a free aperture size of 4.2 angstroms. Not wishing to be bound by any theory, the cations are also probably responsible for the very strong and selective electronic forces which are unique to these adsorbents. In the case of zeolites, selectivity is influenced by the electronic effects of the cations in the cavity as well as the size of the apertures in the alumino-silica framework. Therefore, zeolites can be tailored to adsorb specific molecules by varying the size of the pores and the attractive forces.

Zeolites are frequently categorized by their crystalline unit cell structure (See W. M. Meier, D. H. Olson, and Ch. Baerlocher, Atlas of Zeolite Structure Types, Elsevier Press (1996) 4th ed.) Those suitable for use as stabilizers in the present invention include compounds characterized as zeolite A, zeolite P, zeolite X, and zeolite Y. In the present invention, any suitable zeolite can be used to trap the desired foaming agent. The appropriate zeolite is dependent on the size, electronegativity and polarizability of the foaming agent desired to be trapped. Appropriate zeolites for the present invention include, but are not limited to, Type 3A, 4A, 5A, 13X and combinations thereof (the A represents angstroms, and 13X has a pore size greater than 5A). While other zeolites may also be useful in the present invention, the preferred zeolite type is zeolite A.

A wide variety of zeolites are available, each with its own specific and uniform pore size. This variety allows for the zeolite to be chosen on the basis of the material to be adsorbed. Generalized pore size and adsorbtion characteristics of type 3A, 4A, 5A and 13X molecular sieves are as follows: Type 3A may be used to adsorb molecules with an effective diameter of less than 3 angstroms, including water and ammonia, and excludes molecules with a diameter of more than 3 angstroms, such as ethane; Type 4A may be used to adsorb molecules with an effective diameter of less than 4 angstroms, including ethanol, hydrogen sulfide, carbon dioxide, sulfur dioxide, ethylene, ethane, and propene, and excludes molecules with an effective diameter greater than 4 angstroms, such as propene; Type 5A may be used to adsorb molecules having an effective diameter of less than 5 angstroms, including n-butanol, n-butane, saturated hydrocarbons from methane to molecules containing twenty-two carbons, R-12, and excludes molecules having an effective diameter of greater than 5 angstroms, including iso-compounds and four carbon ring compounds; 13X may be used to adsorb molecules having an effective diameter less than 10 angstroms, and excludes molecules having an effective diameter greater than 10 angstroms. Each type molecular sieve adsorbs molecules of the lower type, i.e., Type 5A may adsorb molecules adsorbed by Type 4A, and so forth; however, it is believed that such adsorbtion may be less efficient than using a zeolite with pore size more closely analogous to the size of the molecule being adsorbed, especially in effective retention of the adosorbed foaming agent prior to and during processing.

Adsorbents, such as solids, liquids or gases (preferably liquids and gases), are held by zeolites via strong physical and/or chemical forces, such as ionic forces, covalent forces and electrostatic attractions. Adsorbents can be desorbed by the application of heat, change in pressure or by displacement with another material, leaving the crystal structure of the molecular sieve in the same chemical state as when it entered. Adsorption and desorption are generally completely reversible with the respective isotherm curves coinciding completely. Isotherm curves can be used to regulate the adsorption and desorption of the foaming materials.

Zeolites possess a very high surface area; for example, the external surface area only comprises approximately one percent (1%) of the total surface area. The entire surface area of the zeolites is capable and available for adsorbing molecules. Therefore, the external surface area of the zeolites is available for adsorbing molecules of all sizes, whereas the internal surface area is available only to molecules small enough to enter the pores. However, because the external surface comprises approximately one percent (1%) of the total surface area, materials too large to be adsorbed within the pores will usually only be adsorbed by the external surface to the extent of 0.2 to 1 weight percent.

As mentioned, zeolites will not only separate molecules based on size and configuration, but they will also adsorb preferentially based on polarity or degree of chemical unsaturation. Therefore, molecules are held more tightly in the crystal structure if they are less volatile, more polar, or less chemically saturated. Some of the strongest adsorptive forces are due to cations acting as sites of strong, localized, positive charge that electrostatically attract the negative end of polar molecules. Polar molecules are molecules containing heteroatoms such as O, S, Cl, F, or N and are asymmetrical. Dipole moments can also be induced by cations present in the zeolites, resulting in the attraction of sites of unsaturation over saturated bonds. In view of these means of attraction, the ability of zeolites to adsorb and retain the foaming agent is based not only on molecular size, but additionally on the basis of electronic forces. For example, zeolites will adsorb carbon monoxide in preference to argon and olefins in preference to saturated hydrocarbons.

The zeolite framework is made up of SiO2 tetrahedra linked by shared oxygen atoms. Substitution of aluminum for silicon creates a charge imbalance that requires a non-framework cation to balance the charge. These cations, which are contained inside the channels and cages of these materials, may be replaced by other cations giving rise to ion exchange properties. The water in these materials may typically be reversibly removed leaving the host structure intact, although some framework distortion may occur. In addition, these materials are typically alkaline. Suspensions of low SiO2.Al2O3 ratio materials in water often give rise to a pH greater than 9. This combination of high alkalinity and the pore structure of these compounds is believed to be largely responsible for the ability of these zeolites to stabilize halogenated polymers by neutralizing acids released during processing and creating inert salts and/or scavenging excess cationic metals.

While the number of moles of SiO2 per molecule of aluminosilicate, represented in the formula by y, may be in the range of about 1.8 or greater, it is suitably about 1.85 to about 15, more suitably about 1.85 to about 10, preferably in the range of about 2 to about 5, and more preferably in the range of about 1.8 to about 3.5.

The number of moles of water in the zeolite as water of hydration, represented in the formula by w, is generally greater than about 0.1, more generally in the range of about 0.1 to about 10.

Preferably, there is employed a zeolite which is substantially anhydrous; that is, a zeolite in which much of the water of hydration has been removed by dehydration prior to incorporation into the halogenated polymer formulation. Such products are frequently referred to by those skilled in the art as “activated” zeolites. Suitable activated zeolites particularly useful in the present invention are those which have been dehydrated to a level at which the water content thereof is in the range of about 0.1% to about 20%, advantageously in the range of about 0.5% to about 18%, more advantageously in the range of about 1% and about 15%, and most advantageously to less than 10%, by weight of the zeolite. In a preferred embodiment as described below, the zeolite is steam calcined to a water content of less than about 8% by weight of the zeolite.

It is desirable that the zeolite have a mean particle size in the range of about 0.1 to about 10 microns, suitably wherein at least about 90% of the particles are: less than about 50 microns, advantageously less than about 25 microns, and more advantageously less than about 10 microns. It is also desirable that the zeolite have a mean micropore diameter in the range of about 2.8 to about 8A, and/or an external surface area in the range of about 3 to about 300 square meters/g. Such zeolites, the processes for producing them, and the drying process used to dehydrate them (described below) are more fully described in U.S. Pat. Nos. 6,096,820 and 6,414,071.

It is known to dehydrate zeolites by a number of processes to reduce the degree of hydration. In the above '820 and '071 patents, steam calcination under certain conditions is preferred, as the resulting dehydrated zeolite will not substantially rehydrate following such dehydration. In those two patents, it is described that subjecting low silica-to-alumina ratio zeolites to moderate steam calcination conditions minimizes deterioration of the crystalline structure of the zeolite and provides a dehydrated zeolite that does not significantly rehydrate. A calcination temperature of about 400 to about 700.degree. C. using a steam percentage of about 20% to about 100% steam, for a time and at a pressure sufficient to dehydrate the zeolite to a water content of about 8% or less by weight of the zeolite while maintaining at least 50% of the crystallinity of the zeolite, has been found to prevent rehydration of the dehydrated zeolite to a water content of more than about 10% by weight of the zeolite. For example, 50% steam at 650.degree. C. for 1 hour at atmospheric pressure is said to be effective. It is also contemplated in those patents that 100% steam at 400.degree. C. for approximately 1-5 hours, or conversely 20%-80% steam at 700.degree. C. for 15 minutes to 1 hour, may be also be effective.

Any suitable foaming agent that can be adsorbed by zeolites can be used to foam the foamable material. Suitable foaming agents include but are not limited to inert gases, saturated aliphatic hydrocarbons, saturated alicyclic hydrocarbons, aromatic hydrocarbons, halogenated hydrocarbons, and ethers, ketones, and alcohols from one to eight carbons in length. Examples of these foaming materials include carbon dioxide, nitrogen, methane, ethane, propane, butane, pentane, hexane, methylpentane, dimethylbutane, methylcyclopropane, cyclopentane, cyclohexane, methylcyclopentane, ethylcyclobutane, isopropyl alcohol, propyl alcohol, ethanol, butanol, isobutanol, sec-butanol, heptanol, pentanol, isopentanol, hexanol, 1,1,2-trimethylcyclopropane, dichlorodifluoromethane, monochlorodifluoromethane, trichlorotrifuoroethane, sulfur hexafluoride, dichlorotetrafluoroethane, dichlorotrifluoroethane, monochlorodifluoroethane, tetrafluoroethane, dimethyl ether, 2-ethoxy-acetone, methyl ethyl ketone, acetyl acetone, dichlorotetrafluorethane, monochlorotetrafluoroethane, dichloromonofluoroethane and difluoroethane. Although not all of the above mentioned foaming agents can be adsorbed by the zeolites in the preferred embodiment(s) of the present invention, generally, those skilled in the art may determine which foaming agent(s) can be used with any particular zeolite(s), either by general knowledge in the art, or by minor experimentation.

Foamable materials capable of being employed in the present invention and foamed with the blowing agent(s) include but are not limited to natural and synthetic resins, acrylonitrilebutadiene rubbers, viscous setable ceramic materials and blends thereof, polyolefins (for example, low and high density polyethylene and polypropylene), olefin copolymers (for example, copolymers of ethylene and ethylvinylacetate), polyaromatic olefins, styrenic compounds and polymerized halo-diolefins (for example, neoprene), ethylene-propylene copolymers, polyvinyl chloride, polycarbonate, polyesters, and polyalkenylaromatics (poly-alpha methylstyrene and polystyrene).

The most preferred foamable materials are the polyalkenylaromatics. The polyalkenylaromatics can be, for example, styrene polymers. The styrene polymers included in the compositions of the invention are homopolymers of styrene and copolymers and interpolymers of styrene containing a predominant proportion of styrene, e.g. greater than 50 weight percent, and preferably greater than 75 weight percent, styrene. Examples of monomers that may be interpolymerized with the styrene include alpha, beta-unsaturated monocarboxylic acids and derivatives thereof, e.g. acrylic acid, methyl acrylate, ethyl acrylate, butyl acrylate, 2-ethylhexyl acrylate and the corresponding esters of methacrylic acid, acrylamide, methacrylamide, acrylonitrile, methacrylenitrile, maleic anhydride, etc.

If desired, blends of the styrene polymer with other polymers may be employed, e.g. blends of the styrene polymer with grafted rubbery diene polymers, or the analogous compositions obtained by dispersing a rubber diene polymer in the styrene monomer and, optionally, other monomers, and subsequently polymerizing the mixture. In any of the above type resins, all or a portion of the styrene may be replaced with its closely related homologues such as alpha-methylstyrene, o-, m-, and p-methylstyrenes, o-, m-, and p-ethylstyrenes, 2,4-dimethylstyrene, bromostyrene, chlorostyrene, and the like. Copolymers of alkenyl aromatic, e.g. styrene, and alkenyl nitrile, e.g., acrylonitrile can also be used and can have a weight ratio of styrene to acrylonitrile of 95:5 to 5:95 respectively. The rubber-containing blends can have the diene rubber moiety present in amounts of about 1 to 35% of grafted diene rubber particles dispersed in a matrix polymer or copolymer as a polyblend. Generally, the rubber particles are grafted with the polymers having the same composition as the matrix phase. The diene rubbers can be polybutadiene or copolymer rubbers having at least 50% by weight of a diene monomer, e.g., butadiene, chloroprene, isoprene or pentadiene. Comonomers copolymerizable with the diene monomers can be those disclosed above.

Still a further embodiment of the present invention is the use of the blowing agent in the foaming process. As mentioned earlier, an advantage of the blowing agent comprising a molecular sieve and a foaming material is that the foaming material (usually a gas) is introduced into the resin prior to extrusion, thus eliminating the need for a gas injector. In addition, the zeolite also functions as a nucleation site, thus reducing or eliminating the need to add a separate nucleating agent, such as talc. Furthermore, gas bubbles combining in the foaming process to form non-uniform pockets of bubbles is decreased when zeolites are used to carry the foaming agent, because release of the foaming agent is produced at the site of nucleation, the zeolite. The zeolites, being both uniform in size and the site of gas formation, result in uniform bubbles being formed in the foamed product.

Foamed products are prepared with the blowing agent of the present invention by any of the known methods in the art. For example, the blowing agent is mixed with a suitable foamable material and extruded or molded by a suitable method, such as pressure molding, die molding, paste molding, calendar molding, extrusion molding or injection molding. Molding means forming an article by deforming the blowing agent-foamable material mixture in the heated molten state. The foamable blowing agent-foamable material mixture is added to the extruder through a hopper, where the mixture is thoroughly blended and exposed to heat to expand the resin and form a foamed product. Here again, the characteristics of the foamed product can be varied depending on the foaming conditions and the specific compositions used in the process.

The blowing agent-foamable material mixture can be used to create foam in single screw extrusion, multi-screw extrusion or tandem screw extrusion processes. Because of the nature of the zeolite structure, the blowing agent mixes more thoroughly with the foamable material to form a homogenous mixture than other gaseous foaming agents added via a gas injection system. Uniform mixing results in a consistent product with a uniform cellular structure.

During the foaming process, the blowing agent-foamable material is preferably exposed to temperatures and pressures that have been preselected for the specific foamable material and blowing agent employed and product characteristics desired. Preferably, the blowing agent-foamable material composition is exposed to high temperatures and pressures characterized as supercritical conditions. Supercritical conditions are conditions at which the gas is in a “fourth” state of matter, being neither a gas, liquid or a solid, but a fourth state which exhibits unique qualities. Once the gas is exposed to supercritical conditions, gas passes to a low pressure zone in the extruder so that the foaming agent adsorbed within the zeolite is released, resulting in the foaming of the foamable material. Upon cooling, the desired foamed product is solidified, producing a uniform cellular structure. Any suitable method of foaming, injection molding or extruding known in the art may be used with the present blowing agent to form foamed resins.

The mixture of the blowing agent and the foamable material may vary widely, depending on the characteristics of the foamed product desired. However, the blowing agent composition is generally used in an amount of about 0.05% to about 50% by weight, preferably about 0.25% to about 20% by weight, and most preferably in an amount 0.5% to about 10% by weight, based on the weight of the total foamable material employed. The temperature at which foaming occurs is dependent upon the blowing agent and the foamable material used, as well as the foamed product desired.

Different blowing agents may also be added to the foamable material to obtain desired foamed product characteristics. In addition, differing proportions of blowing agents can be combined to optimize the foam characteristics, such as flexibility, rigidity, strength and durability of the foamed product. Furthermore, by varying the rheology of the foamable material mixture, the temperature window for foaming certain foamable materials can be broadened, resulting in the foaming of certain foamable materials that have heretofore been difficult to foam. In addition, varying the blowing agent can affect such properties as the melt strength of the polymer to form sturdier products.

In the present invention, the most preferred zeolites are the ADVERA 401 PS, ADVERA 401P and ADVERA 401F sodium aluminosilicate hydrated type Na-A zeolite powders, all available from PQ Corporation. Each of the ADVERA zeolites has: an average nominal chemical composition of 17% Na2O, 28% Al2O3, 33% SiO2, and 22% H2O; a nominal pore size diameter of 4A; and a moisture loss at 800 degrees C. of 18%-22% by weight. These zeolites vary somewhat in average particle size and particle size distribution.

Also in the present invention, the preferred foaming agent is comprised of carbon dioxide. To introduce the carbon dioxide into the zeolite structure, the (optimal) first step is to dry the zeolite to remove at least a portion, and preferably nearly all, bound or absorbed moisture. To accomplish this, the zeolite is first heated, preferably in the temperature range of 150° C.-800° C. The preferred temperatures are between 300° C. and 400° C., and most preferably approximately 350° C. Although the drying can be accomplished by means other than heating, the preferred temperatures allow for the uptake of carbon dioxide by the zeolite to be effected more readily. The drying of the zeolite should be undertaken for a period sufficient to remove bound or absorb moisture to the desired degree. To this end, any sufficient time is suitable. While the zeolite is being dried, it is helpful to maintain the humidity in the drying chamber at as low a level as possible.

Although drying is preferred because it eliminates competition between water and carbon dioxide for absorption sites in the zeolite, it is not absolutely necessary in all instances. Once the zeolite is dried to the extent desired, the zeolite is then charged with carbon dioxide, either in gas or solid form (such as dry ice). Any suitable method to contact the zeolite and carbon dioxide may be used. At this point the zeolite containing the added carbon dioxide can be used as is. Alternatively, the zeolite containing the added carbon dioxide may be put in a carrier system and pelletized, or coated by conventional techniques using resins, preferably barrier resins such as EBA, SEBS, SIBS, acrylic or acquilanitrile. Also alternatively, the zeolites containing the added carbon dioxide can be prilled or pelletized with compounding equipment. The zeolites containing carbon dioxide, whether used as is, or compounded with a resin, preferably a barrier resin, can then be used to foam a foamable material, preferably an alkenylaromatic resin, or wood-filled or wood fiber-filled thermoplastic resin.

All of the patents mentioned and referred to herein are incorporated herein by refernce and their disclosures are fully part of this application. The present invention has been described with preferred embodiments. It is to be understood however that modifications and variations may be resorted to, without departing from the spirit and scope of the invention, as those skilled in the art would readily understand. These modifications and variations are considered to be within the scope of the appended claims.

What is claimed is:

1. A process for producing blowing agent, said process comprising:
(a) drying zeolite to remove at least a portion of any water adsorbed in the zeolite; and
(b) exposing the zeolite obtained from step (a) to a source of foaming agent so that the foaming agent is adsorbed in the zeolite in an amount of at least 30% by weight, based on the weight of the zeolite plus foaming agent, to form a blowing agent.

2. A process according to claim 1, wherein the zeolite has a pore size of approximately 4A and the water adsorbed in the zeolite is reduced by drying to an amount less than 10% by weight, based on the weight of the zeolite and remaining water; and the foaming agent consists essentially of carbon dioxide.

3. A process according to claim 1, comprising the further step of:
(c) encapsulating the blowing agent obtained from step (b) to form an encapsulated blowing agent.

4. A process according to claim 2, comprising the further step of:
(c) encapsulating the blowing agent obtained from step (b) to form an encapsulated blowing agent.

5. A process according to claim 1, comprising the further step of:
(c) pelletizing the blowing agent obtained from step (b) in a suitable carrier to form pelletized blowing agent.

6. A process according to claim 2, comprising the further step of:
(c) pelletizing the blowing agent obtained from step (b) in a suitable carrier to form pelletized blowing agent.

7. The blowing agent produced by the process recited in claim 1.

8. The blowing agent produced by the process recited in claim 2.

9. The blowing agent produced by the process recited in claim 3.

10. The blowing agent produced by the process recited in claim 4.

11. The blowing agent produced by the process recited in claim 5.

12. The blowing agent produced by the process recited in claim 6.

13. A process for producing foamed product, said process comprising:
(a) heating a foamable material to a temperature above its melting point to form a melted foamable material;
(b) adding to the melted foamable material a blowing agent comprised of zeolite and foaming agent, wherein said foaming agent is present in the blowing agent in an amount of at least 30% by weight;
(c) mixing the combination of foamable material and blowing agent under conditions which retard foaming of the foamable material; and
(d) subjecting the combination of foamable material and blowing agent to conditions which induce release of the foaming agent.

14. A process for producing foamed product, said process comprising:
(a) heating a foamable material selected from the group of polystyrene, wood-filled themoplastic and wood fiber-filled thermoplastic to a temperature above the melting point of said foamable material to form a melted foamable material;
(b) adding to the melted foamable material a blowing agent comprised of zeolite having a pore size of about 4A and foaming agent consisting essentially of carbon dioxide, wherein said foaming agent is present in the blowing agent in an amount of at least 30% by weight;
(c) mixing the combination of foamable material and blowing agent under conditions which retard foaming of the foamable material; and
(d) subjecting the combination of foamable material and blowing agent to conditions which induce release of the foaming agent

15. The foamed product produced by the method recited in claim 13.

16. The foamed product produced by the method recited in claim 14.

17. The foamed product produced by the method recited in claim 13 which comprises an open-cell foam product.

18. The foamed product produced by the method recited in claim 14, which comprises an open-cell foam product.
